(19) United States
(12) Patent Application Publication
(10) Pub. No.: US 2011/0186178 A1
(43) Pub. Date: Aug. 4, 2011

(54) Safety device for an electric pencil sharpener

(76) Inventor: Shen-Hsiung Chang, Danshuei Township (TW)

(21) Appl. No.: 12/004,487

(22) Filed: Dec. 21, 2007

(51) Int. Cl. B43L 23/00

(52) U.S. Cl. 144/28.5

(57) ABSTRACT

A safety device for an electric pencil sharpener is composed of at least a bracket, a selection turn table, a sliding block, a first switch, and a second switch. After rotating the selection turn table, the sliding block and the first switch are driven to move, such that the second switch is activated to cause a short circuit to the first switch, by a pillar which is formed at a side of the sliding block. The electric pencil sharpener can be only restarted to operate by pressing down manually a press button which is electrically connected with the second switch, so as to reduce danger of cutting a finer when a user puts the finger into a selection hole accidentally.

### BACKGROUND OF THE INVENTION

a) Field of the Invention

The present invention relates to a safety device for an electric pencil sharpener, and more particularly to a safety device which is used in an electric pencil sharpener to switch a power supply mode.

b) Description of the Prior Art

It is known that, conventionally, a pencil is still needed for a user who is doing writing, art designing, or plotting in crafting. Before using a pencil, conventionally, its outer wood layer and inner core should be sharpened into proper conicity, to facilitate holding by the user and drawing a line of proper thickness. However, as it is very time consuming to sharpen the pencil by hands and the pencil is not easily sharpened into the proper conicity, thereby affecting the usage. Therefore, an electric pencil sharpener arises.

Referring to FIG. 1, it shows a schematic view of structures of a conventional electric pencil sharpener. As shown in the drawing, an electric pencil sharpener 10 includes primarily a housing 101, an electric motor 102, a reduction gear set 103, an arbor 104, and a switch 105. The electric motor 102, the reduction gear set 103, and the arbor 104 are assembled in an interior of the housing 101, and a front surface of the housing 101 is disposed with a rotatable selection turn table 106, and a collection box 107 for collecting debris. The selection turn table 106 is radially formed with a plurality of selection holes 1061 of different diameters, and the housing 101 is formed with a through-hole 1011 corresponding to the arbor 104. After rotating the selection turn table 106, one of the selection holes 1061 can be aligned with the through-hole 1011 to assemble the switch 105 between the arbor 104 and the selection turn table 106. In addition, the electric motor 102 transmits power to the arbor 104 through the reduction gear set 103, and the switch 105 is electrically connected with a power supply 108. Therefore, the power needed to operate the electric motor 102 can be provided. As diameters of pencils 20 which are sold on a market are various, the user should rotate the selection turn table 106 first to select the selection hole 1061 which is suitable to the diameter of the pencil 20. Then, the pencil 20 can be inserted into the selection hole 1061 to activate the switch 105 to drive the electric motor 102 to operate and to drive the arbor 104 to rotate, thereby sharpening the pencil 20.

Accordingly, this kind of electric pencil sharpener 10 is provided with following shortcomings:

1. As the switch 105 is fixedly located in the housing 101, when the selection turn table 106 is rotated to the different selection hole 1061, a position of the switch 105 relative to each selection hole 1061 will be different. More particularly, when the selection hole 1061 of a smaller diameter is selected, too large an area will usually cover on the selection hole 1061, resulting in that the pencil 20 will not be inserted easily. On the other hand, if an installation position of the switch 105 is changed, then it is also possible to prohibit the pencil 20 from successfully activating the switch 105 when the selection hole 1061 of a larger diameter is used.

2. For most of this kind of electric pencil sharpener 10, the sharpening will be conducted automatically after activating the switch 105; therefore, if the selection hole 1061 of a larger diameter is selected, then the user or a child can insert a finger into the selection hole 1061 accidentally, thereby causing the finger to be cut by the arbor 104.

### SUMMARY OF THE INVENTION

The primary object of the present invention is to provide a safe device for an electric pencil sharpener which facilitates sharpening a pencil and improves safety.

Accordingly, a safety device for an electric pencil sharpener of the present invention includes at least a bracket, a selection turn table, a sliding block, a first switch, and a second switch; whereas, the electric pencil sharpener includes primarily a housing, an electric motor, a reduction gear set, and an arbor. The electric motor, the reduction gear set, and the arbor are assemble'd in an interior of the housing, and a front surface of the housing is formed with a through-hole and a limiting hole. The arbor is corresponding to the through-hole of the housing, and two surfaces of the selection turn table are formed respectively with a plurality of selection holes, and a slot ring which is at a different distance from each selection hole, in order to dispose the selection turn table at an exterior side of the housing. The sliding block is disposed on the bracket at an interior side of the housing, and is formed with a pillar which passes through the limiting hole to be inserted into the slot ring. Therefore, in usage, through rotating the selection turn table, one of the selection holes can be aligned with the through-hole on the housing, such that a pencil can be inserted into the through-hole for sharpening. On the other hand, when rotating the selection turn table, the sliding block will move up and down along a path of the slot ring, and the first switch, which is installed on the sliding block correspondingly, will also move up and down along with the sliding block, allowing the first switch to be always kept at an optimal position of the selection hole. In addition, the first switch is electrically connected with a power supply, so as to facilitate the pencils of various diameters to be inserted successfully, such that the first switch can activate the electric motor to operate after inserting the pencil, and power can be transmitted to the arbor through the reduction gear set. Furthermore, the second switch is located at a side of the first switch, and is electrically connected with the first switch.

On the other hand, a side of the sliding block is formed with a flange which is used to correspond to the selection hole of a larger diameter on the selection turn table; in other words, when the selection turn table is rotated to the selection hole of a larger diameter, the flange will move upwards to active the second switch, allowing a short-circuit condition to be formed between the first switch and the power supply. Moreover, the second switch is also electrically connected with a press button on the housing, and after the user presses down the press button, the first switch can be restored to drive the power supply to continue supplying the power. Accordingly, when the selection turn table is rotated to the selection hole of a larger diameter, the first switch is failure, and the electric motor will not be activated to operate even the user puts a finger into the selection hole, until the user presses down the press button manually to restart the electric pencil sharpener. Hence, a danger that the finger will be cut when the user or a child puts the finger into the selection hole accidentally can be largely reduced.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of structures of a conventional electric pencil sharpener of the prior art.

FIG. 2 shows a perspective view of a preferred embodiment of the present invention.

FIG. 3 shows an exploded view of a preferred embodiment of the present invention. FIG. 4 shows a schematic view of operations of a preferred embodiment of the present invention. FIG. 5 shows a second schematic view of operations of a preferred embodiment of the present invention.

FIG. 6 shows a schematic view of structures of another preferred embodiment of the present invention.

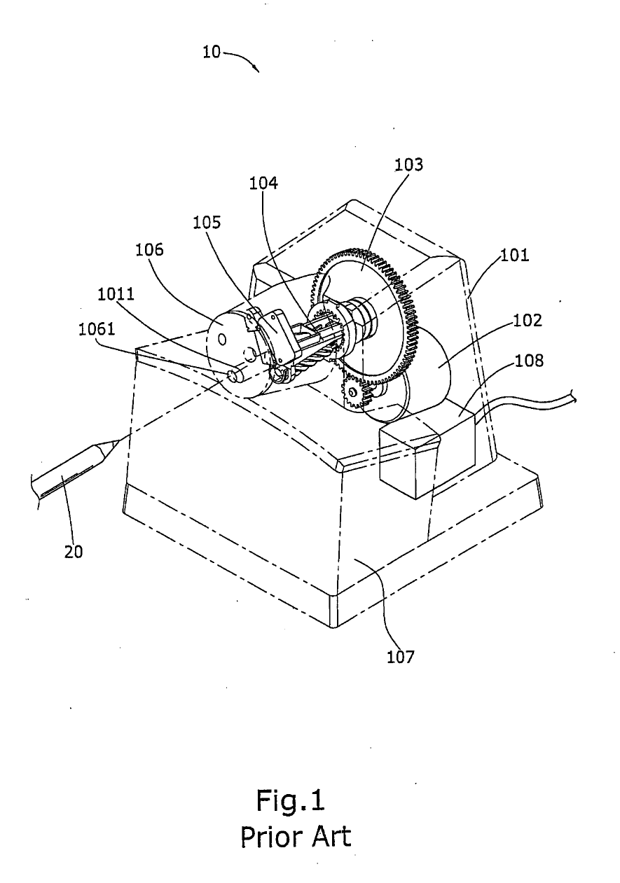

### DETAILED DESCRIPTION OF THE PREFERRED EMBODIMENTS

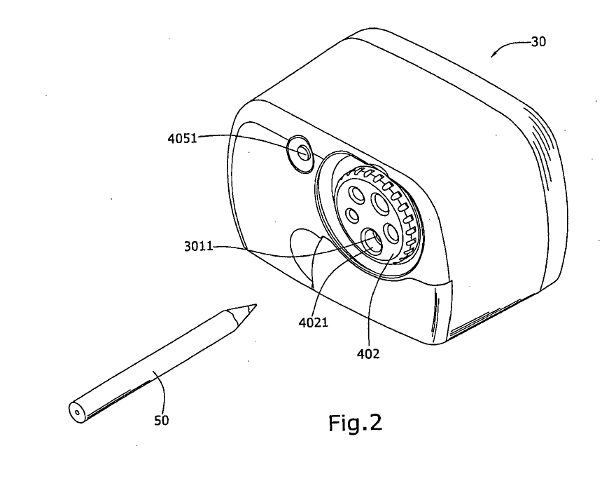

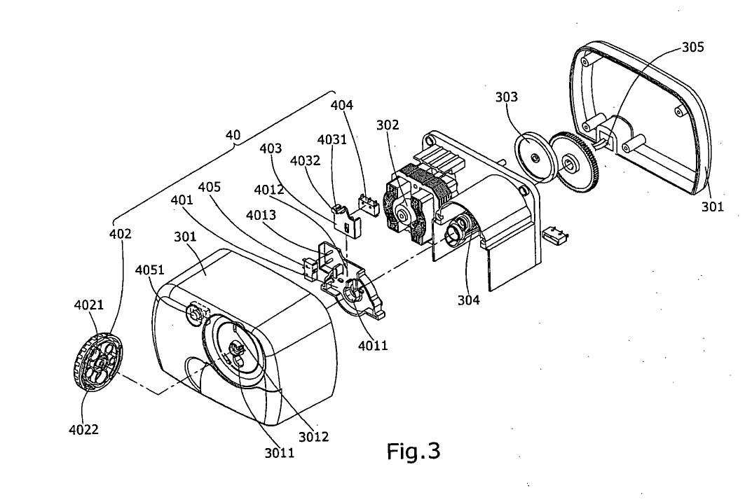

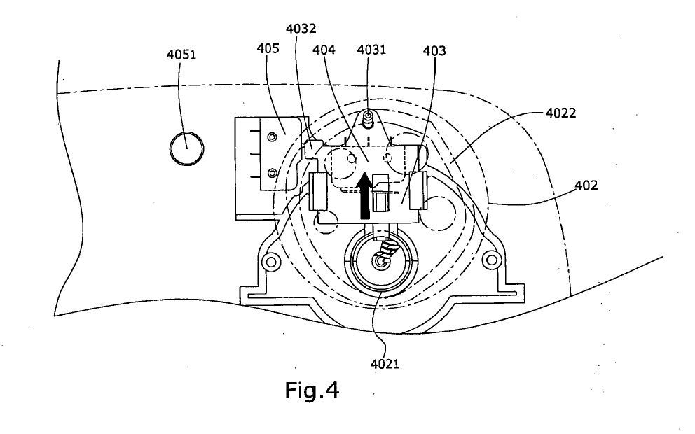

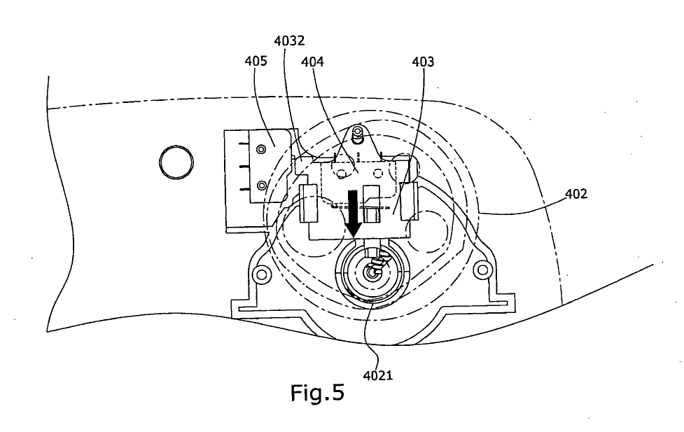

Referring to FIG. 2 and FIG. 3, it shows respectively a perspective view and an exploded view of a preferred embodiment of the present invention, wherein an electric pencil sharpener 30 is constituted by a housing 301, an electric motor 302, a reduction gear set 303, and an arbor 304, with a front surface of the housing 301 being disposed with a press button 4051 and a selection turn table 402. When sharpening a pencil 50, the selection turn table 402 should be rotated first to a selection hole 4021 which corresponds to a diameter of the pencil 50, allowing the selection hole 4021 to be aligned with a through-hole 3011 of the housing 301, such that when the pencil 50 is inserted, it can pass through the selection hole 4021 into the through-hole 3011, and be sharpened by the arbor 304 at a side in an interior surface of the through-hole 3011. The pencil 50 is completely abutted at the selection hole 4021 in sharpening, so as to increase a stability of sharpening and improve a quality of sharpening. A safety device for an electric pencil sharpener 40 includes at least a bracket 401, a center of which is formed with a connection hole 4011 that is connected with the through-hole 3011 of the housing 301 and the arbor 304, with a sliding slot 4012 being formed close to the connection hole 4011, and a first holding chamber 4013 being formed at a side close to the sliding slot 4012; the selection turn table 402, which is disposed at the front surface of the aforementioned housing 301, with the through-hole 3011 being formed at a proper location on the front surface of the housing 301, a limiting hole 3012 being formed at a side of the through-hole 3011, the plural selection holes 4021, each selection hole 4021 corresponding to the position of the through-hole 3011, being formed at the front surface of the selection turn table 402, and a slot ring 4022, having a same distance to each selection hole 4021, being formed at a rear surface of the selection turn table 402; a sliding block 403, which is loosely assembled in an interior of the housing 301, on which is formed with a pillar 4031 that is able to pass through the limiting hole 3012 of the housing 301 to be inserted in the slot ring 4022, and a side of which is formed with a flange 4032 corresponding to a position of the selection hole 4021 of a larger diameter upon installing the sliding block 403; a first switch 404, which is assembled on the sliding block 403 and is electrically connected to a power supply 305 to provide power required for operating the aforementioned electric motor 302 that transmits the power to the aforementioned arbor 304 through the aforementioned reduction gear set 303; and a second switch 405, which is assembled at a side of the first switch 404, and is opposite to the flange 4032 of the sliding block 403, with the flange 4032 being electrically connected with the press button 4051. Furthermore, the second switch 405 is electrically connected between the first switch 404 and the power supply 305, and the press button 4051 can be installed at a top surface of the housing 301, or on the front surface o the housing 301 at a side close to the selection turn table 402. As the second switch 405 is a two-stage switch, after it is abutted by the flange 4032, a first stage operation will be executed to enable the first switch 404 to be short circuited. Next, when the press button 4051 is pressed down again, a second stage operation will be executed to restore the first switch 404 which was short circuited.

Referring to FIG. 4, it shows a schematic view of operations of a preferred embodiment of the present invention, wherein when the aforementioned selection turn table 402 is rotated to the selection hole 4021 of a larger diameter, the pillar 4031 of the sliding block 403 will move linearly along the slot ring 4022 to drive the sliding block 403 to move upwards. The flange 4032 at the side of the sliding block 403 will then activate the second switch 405, enabling the first switch 404, which is electrically connected with the second switch 405, to be short circuited, thereby prohibiting the aforementioned power supply 305 from supplying the power. However, a user can still restore the second switch 405 and the first switch 404 to an energized state by pressing down the aforementioned press button 4051, to facilitate sharpening the aforementioned inserted pencil 50. Referring to FIG. 5, it shows a second schematic view of operations of a preferred embodiment of the present invention. When the selection turn table 402 is rotated again to the selection hole 4021 of a smaller diameter, the sliding block 403 will move downwards, enabling the flange 4032 to be separated with the second switch 405, such that the first switch 404 can be restored to the energized state naturally.

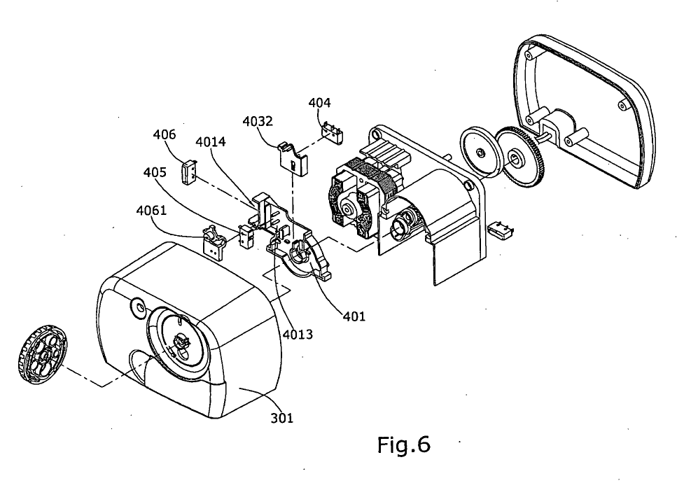

Referring to FIG. 6, it shows a schematic view of structures of another preferred embodiment of the present invention, wherein a second holding chamber 4014 is formed at a side of the bracket 401 close to the first holding chamber 4013, to assemble a third switch 406 in an interior of the second holding chamber 4014; whereas, a press button 4061 is disposed on the housing 301 corresponding to the third switch 406, and the third switch 406 is electrically connected with the aforementioned power supply 305 and the press button 4061. When the aforementioned second switch 405 is abutted by the flange 4032 of the sliding block 403 and the first switch 404 is short circuited, the user can still enable the power supply 305 to continue supplying the power by pressing down the press button 4061.

Accordingly, the present invention is provided with following advantages:

1. When the selection turn table is rotated to the corresponding selection hole, the sliding block can be driven to move back and forth, allowing the first switch to move to the optimal position of the selection hole following the movement. Therefore, the pencils of all kinds of diameters can be sharpened successfully.

2. Furthermore, by using the plural sets of switches as a safety design, when the user rotates the selection turn table to the selection hole of a larger diameter, the power will be cut off automatically, and electricity is accessed by pressing down the press button manually, thereby reducing a danger that a finger will be cut when the user or a child puts the finger into the selection hole accidentally.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A safety device for an electric pencil sharpener comprising at least a bracket, which is assembled in an interior of a housing, and a center of which is formed with a connection hole, with a sliding slot being formed close to the connection hole, and a first holding chamber being formed at a side close to the sliding slot; a selection turn table, which is disposed at a front surface of the housing, with the front surface of the housing being formed with a through-hole and a limiting hole, a front surface of the selection turn table being formed with a plurality of selection holes, allowing each selection hole to correspond to a position of the through-hole, and a rear surface of the selection turn table being formed with a slot ring; a sliding block, which is loosely assembled in an interior of the sliding slot, and is formed with a pillar, with the pillar passing through the limiting hole of the housing to be inserted into the slot ring, and a side of the sliding block being formed with a flange; a first switch, which is assembled on the sliding block and is electrically connected with a power supply to provide the power required for operating an electric motor that transmits the power to an arbor through a reduction gear set; and a second switch, which is assembled in an interior of the first holding chamber, and is opposite to the flange of the sliding block, with the flange being electrically connected with a press button, and the second switch being electrically connected between the first switch and the power supply.

2. The safety device for an electric pencil sharpener according to claim 1, wherein the second switch is a two-stage switch.

3. The safety device for an electric pencil sharpener according to claim 1, wherein the flange corresponds to the selection hole of a larger diameter.

4. The safety device for an electric pencil sharpener according to claim 1, wherein the press button is disposed on a surface of the housing.

5. The safety device for an electric pencil sharpener according to claim 1, wherein a side of the bracket is formed with a second holding chamber for assembling a third switch which is electrically connected with the power supply and a press button.

6. The safety device for an electric pencil sharpener according to claim 5, wherein the press button is disposed on a surface of the housing.
